(19) United States
(12) Patent Application Publication
(10) Pub. No.: US 2023/0344316 A1
(43) Pub. Date: Oct. 26, 2023

(54) ROTATING ELECTRIC MACHINE

(71) Applicant: Mitsubishi Electric Corporation, Tokyo (JP)

(72) Inventors: Yoshihiro MIYAMA, Tokyo (JP); Shinsuke KAYANO, Tokyo (JP); Kengo Kumagai, Tokyo (JP)

(73) Assignee: Mitsubishi Electric Corporation, Tokyo (JP)

(21) Appl. No.: 18/159,404

(22) Filed: Jan. 25, 2023

(30) Foreign Application Priority Data
Apr. 25, 2022 (JP) 2022-071249

(51) Int. Cl. H02K 11/01; H02K 1/27; H02K 7/00

(52) U.S. Cl. CPC H02K 11/012; H02K 1/27; H02K 7/00

(57) ABSTRACT

An object of the present disclosure is to provide a rotating electric machine in which a centrifugal force can be relaxed and reluctance torque can be improved. A pair of magnet slots are provided so as to be opposed to each other such that the distance therebetween is narrowed toward the radially inner side while being centered on a d axis of a rotor core, a pair of magnets are inserted in the pair of magnet slots, and center flux barriers are provided on the d axis between the pair of magnet slots. The distance in the radial direction between the first-layer center flux barrier and the second-layer center flux barrier is the smallest among distances between a flux barrier layer for first layer and a flux barrier layer for second layer.

### BACKGROUND OF THE INVENTION

### 1. Field of the Invention

The present disclosure relates to a rotating electric machine.

### 2. Description of the Background Art

In an electric generator or a driving motor for a vehicle, an interior-magnet-embedded-type synchronous motor that has permanent magnets embedded inside a rotor core to use magnet torque and reluctance torque in combination, and that improves torque and output, is generally used as a rotating electric machine. In order to improve reluctance torque, a rotating electric machine in which magnets are arranged in multiple layers is used. Then, when a magnetic flux from an armature and a magnetic flux from a magnet pass through a core between layers of the magnets arranged in multiple layers, magnetic saturation may occur, thus reduction in torque is generated. In order to avoid this, the following technology is known.

A first permanent magnet is embedded at the center of a magnetic pole, and a pair of second permanent magnets are embedded on both sides in the circumferential direction of the first permanent magnet and are arranged such that the interval between the pair of second permanent magnets are narrowed inward in the radial direction. In a magnetic path area formed by the first permanent magnet and the pair of second permanent magnets, the narrowest interval between the pair of second permanent magnets is set to be larger than the longitudinal-direction width of the first permanent magnet. By this configuration, the magnetic path area formed between the first permanent magnet and the second permanent magnets is ensured to be large, so that magnetic saturation is less likely to occur, and thus torque can be improved (see Patent Document 1).
Patent Document 1: Japanese Laid-Open Patent Publication No. 2012-161227

In Patent Document 1, a large amount of core is used so that magnetic saturation is less likely to occur. Therefore, in particular, the weight of a core present on the radially outer side of the magnet layer present on the radially innermost side increases, so that a centrifugal force applied to a bridge portion of a rotor core having permanent magnets embedded therein increases. Then, a problem exists in that the rotor core is broken by stress due to the centrifugal force. In order to reduce the stress, it is conceivable to increase the width of the bridge. However, in this case, the amount of a magnet magnetic flux short-circuited in the rotor core increases, and reluctance torque is reduced. Thus, torque is reduced.

### SUMMARY OF THE INVENTION

The present disclosure has been made to solve the above problem, and an object of the present disclosure is to provide a rotating electric machine in which a centrifugal force can be relaxed and reluctance torque can be improved.

A rotating electric machine according to one aspect of the present disclosure includes a stator, and a rotor provided on an inner circumferential side of the stator. The rotor has a rotor core fixed to a shaft, a pair of magnet slots provided so as to be opposed to each other such that a distance therebetween is narrowed toward a radially inner side while being centered at a d axis which is a magnetic pole center of the rotor core, a pair of magnets inserted in the pair of magnet slots, and center flux barriers provided on the d axis between the pair of magnet slots. The magnet slots, the magnets, and the center flux barriers are respectively configured so as to make N layers when N is an integer not less than 2. N flux barrier layers are formed by the magnet slots in the N layers and the center flux barriers in the N layers, and a distance in a radial direction between the (N−1)th-layer center flux barrier and the Nth-layer center flux barrier is the smallest among distances between the flux barrier layer for (N−1)th layer and the flux barrier layer for Nth layer.

In the rotating electric machine according to the present disclosure, a centrifugal force can be relaxed and reluctance torque can be improved.

### BRIEF DESCRIPTION OF THE DRAWINGS

FIG. 1 is a sectional view taken along the axial direction, showing a rotating electric machine according to the first embodiment of the present disclosure;

FIG. 2 is a sectional view taken along a direction perpendicular to a rotation axis of the rotating electric machine according to the first embodiment;

FIG. 3 is a sectional view taken along a direction perpendicular to the rotation axis of a rotor of the rotating electric machine according to the first embodiment;

FIG. 4 is a sectional view taken along a direction perpendicular to the rotation axis of the rotor of the rotating electric machine according to the first embodiment;

FIG. 5 is a sectional view taken along a direction perpendicular to a rotation axis of a rotor of a rotating electric machine according to the second embodiment of the present disclosure;

FIG. 6 is a sectional view taken along a direction perpendicular to a rotation axis of a rotor of a rotating electric machine according to the third embodiment of the present disclosure;

FIG. 7 is a sectional view taken along a direction perpendicular to a rotation axis of a rotor of a rotating electric machine according to the fourth embodiment of the present disclosure;

FIG. 8 is a sectional view taken along a direction perpendicular to a rotation axis of a rotor of a rotating electric machine according to the fifth embodiment of the present disclosure;

FIG. 9 is a sectional view taken along a direction perpendicular to a rotation axis of a rotor of a rotating electric machine according to the sixth embodiment of the present disclosure; and

FIG. 10 is a sectional view taken along a direction perpendicular to a rotation axis of a rotor of a rotating electric machine according to the seventh embodiment of the present disclosure.

### DETAILED DESCRIPTION OF THE PREFERRED EMBODIMENTS OF THE INVENTION

### First Embodiment

The present embodiment relates to a rotating electric machine in which a centrifugal force is reduced and reluctance torque is improved.

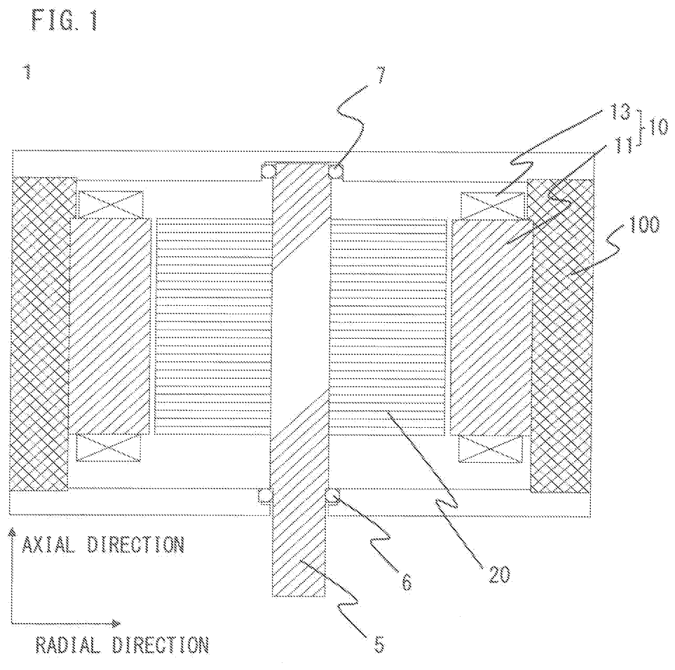

FIG. 1 is a sectional view taken along the axial direction, showing the rotating electric machine. In FIG. 1, the direction in which a rotation axis extends is defined as axial direction, and a direction perpendicular to the axial direction is defined as radial direction. In FIG. 1, a motor 1 as the rotating electric machine is composed of a stator 10 and a rotor 20 stored in a frame 100. In the rotor 20, both ends in the axial direction of a shaft 5 are rotatably retained by a load-side bearing 6 and a anti-load-side bearing 7. The stator 10 is composed of a stator core 11 having tooth portions protruding in the radial direction from an annular yoke portion toward the rotor 20, and stator coils 13 wound around the tooth portions.

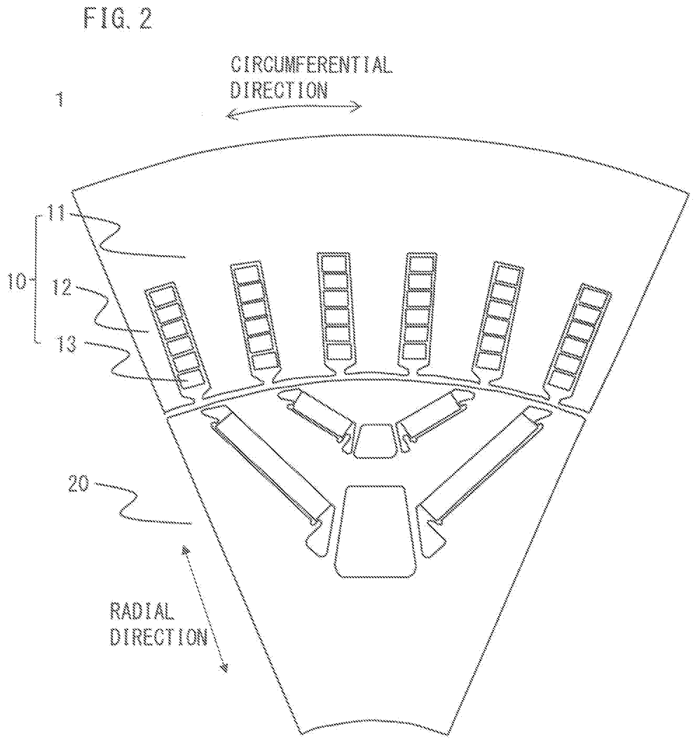

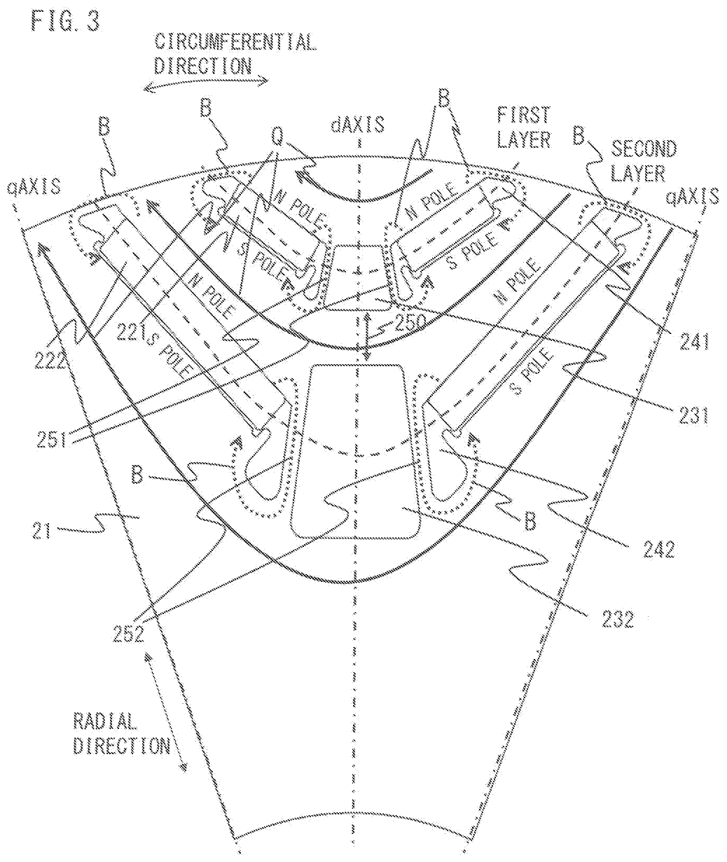

FIG. 2 is sectional view taken along a direction perpendicular to the rotation axis of the rotating electric machine according to the first embodiment, and FIG. 3 is a sectional view taken along a direction perpendicular to the rotation axis of the rotor of the rotating electric machine according to the first embodiment. In FIG. 2 and FIG. 3, a circumferential direction in which magnets are arranged is defined as circumferential direction.

In FIG. 2, the motor 1 as the rotating electric machine has the stator 10, and the rotor 20 disposed coaxially on the inner circumferential side of the stator 10.

As shown in FIG. 2, the stator 10 has stator teeth 12 extending radially inward from the annular stator core 11, stator slots which are U-shaped areas surrounded by the adjacent stator teeth 12 and the stator core 11, and stator coils 13 arranged in the stator slots. In the first embodiment, forty-eight stator teeth 12 are uniformly formed in the circumferential direction, and six wires of the stator coil 13 are arranged in the radial direction in each of the forty-eight stator slots. Each stator coil 13 is connected in series to another stator coil 13 at the sixth adjacent position in the circumferential direction, thus distributed winding is configured. In FIG. 2, a part corresponding to 1/8 of the rotating electric machine is shown, and eight such parts shown in FIG. 2 are connected in an annular shape, whereby a cross-section of the entire rotating electric machine is formed.

As shown in FIG. 3, the rotor 20 has an annular rotor core 21 fixed to the shaft 5, and a pair of first-layer magnet slots 241 and a pair of second-layer magnet slots 242. And each pair of slots is provided so as to be opposed to each other such that the distance therebetween is narrowed toward the radially inner side while being centered at a d axis which is a magnetic pole center of the rotor core 21. In the pair of first-layer magnet slots 241, a pair of first-layer magnets (permanent magnets) 221 are inserted. And in the pair of second-layer magnet slots 242, a pair of second-layer magnets 222 are inserted. Further, a first-layer center flux barrier 231 is provided between the pair of first-layer magnet slots 241. The first-layer center flux barrier 231 is located on the d axis. The flux barrier is provided in order to prevent occurrence of a leakage magnetic flux. In addition, a second-layer center flux barrier 232 is provided between the pair of second-layer magnet slots 242. The second-layer center flux barrier 232 is located on the d axis.

In the present embodiment, magnet torque is generated by attraction and repulsion between a pole of a rotating magnetic field and a magnetic pole of the permanent magnet of the rotor. And reluctance torque is generated by only an attraction force between a pole of a rotating magnetic field of the stator and a salient pole of the rotor. In the direction of a q axis, a magnetic resistance (reluctance) of a magnetic path is small, and the q axis is not related to S and N poles of the rotor. Regarding axes of magnetic poles of the rotor, the direction of a magnetic flux formed by a magnetic pole (permanent magnet center axis) is defined as d axis, and an axis that is electrically and magnetically perpendicular thereto is defined as q axis.

The pair of first-layer magnets 221 and the pair of second-layer magnets 222 have flat-plate shapes. As shown by S poles and N poles in FIG. 3, these magnets are oriented in parallel to short sides thereof, and are magnetized so as to be all directed toward the same direction in the radial direction. These four magnets form one set of magnets, and eight sets of such magnets are arranged at equal intervals in the circumferential direction. Between adjacent sets in the circumferential direction, the magnetization directions are alternately directed toward the radially inner side and the radially outer side. That is, the part adjacent to the 1/8 part shown in FIG. 3 has a structure in which S poles and N poles are reversed.

Thus, the motor 1 of the present embodiment is formed as an interior-embedded-magnet-type synchronous motor having 8 poles and 48 slots. In FIG. 3, the first-layer center flux barrier 231 and the pair of first-layer magnet slots 241 as a flux barrier are arranged so as to block a d-axis magnetic flux and allow a q-axis magnetic flux Q to pass, whereby a flux barrier layer for first layer is formed. In addition, the second-layer center flux barrier 232 and the pair of second-layer magnet slots 242 as a flux barrier form a flux barrier layer for second layer. By the flux barrier layer for first layer and the flux barrier layer for second layer, a difference occurs between inductances on the d-axis and the q axis, whereby reluctance torque can be generated. That is, the magnetic resistance (reluctance) on the d axis is larger than the magnetic resistance (reluctance) on the q axis. And regarding inductances, the inductance on the d axis is smaller than the inductance on the q axis. Owing to the difference, reluctance torque is generated.

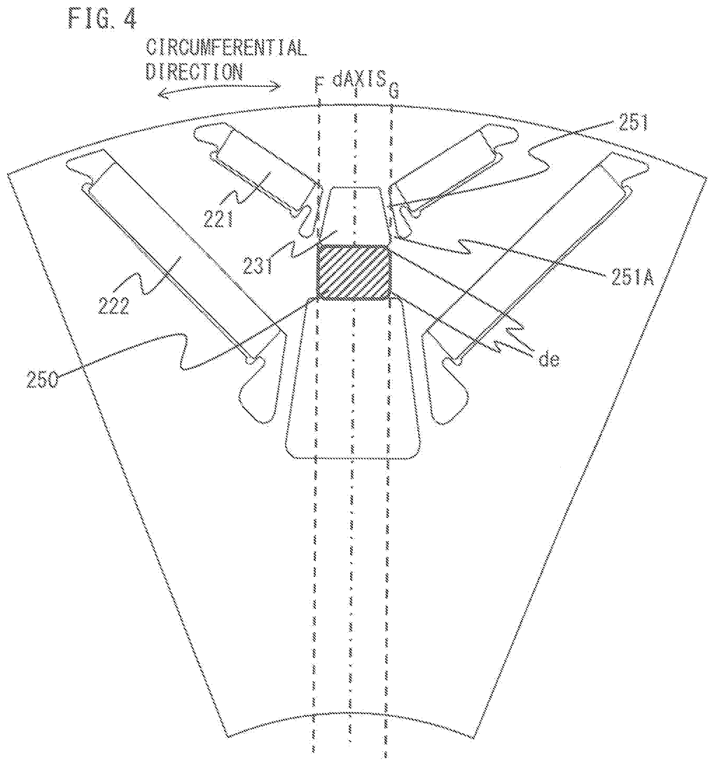

In the flux barrier layer for second layer, the second-layer center flux barrier 232 is formed so as to protrude from the radially outer side and the radially inner side of the layer relative to the second-layer magnet slots 242. The distance in the radial direction between the first-layer center flux barrier 231 and the second-layer center flux barrier 232 is the smallest among distances between the flux barrier layer for first layer and the flux barrier layer for second layer, and this smallest-distance part is defined as narrow portion 250. Between the first-layer magnet slots 241 and the first-layer center flux barrier 231, a pair of first-layer rib portions 251 serving as short-circuit magnetic paths for magnet short-circuit magnetic fluxes B (dotted-line arrows) of the first-layer magnets 221, are formed. An end 251A on the second-layer center flux barrier 232 side of the first-layer rib portion 251 is located on the external side in the circumferential direction with respect to the narrow portion 250. FIG. 4 is a sectional view taken along a direction perpendicular to the rotation axis of the rotor of the rotating electric machine according to the first embodiment, in the same manner as in FIG. 3. In FIG. 4, the narrow portion 250 is actually the entire area indicated by diagonal lines. The above-described configuration can be represented as follows: the ends on the second-layer center flux barrier 232 side of the first-layer rib portions 251 are located on the external side in the circumferential direction of the narrow portion 250 with respect to lines F, G passing ends de of the narrow portion and extending in parallel to the d axis.

Thus, the magnet short-circuit magnetic flux B passing through the first-layer rib portion 251 does not enter the narrow portion 250. That is, the configuration is made such that a magnetic flux passing through a core portion corresponding to a short-circuit magnetic path for a magnet is not present in the narrow portion 250. Here, the state in which a magnetic flux passing through a core portion is not present in the narrow portion 250 is a state in which the narrow portion 250 does not serve as a main magnetic path for a short-circuit magnetic flux of a magnet, i.e., a state in which the first-layer rib portion 251 which is a path having the lowest magnetic resistance other than a path passing through the narrow portion 250 is present between target magnets. Therefore, the state in which the narrow portion 250 does not serve as a main magnetic path for a short-circuit magnetic flux of a magnet is not only a state in which the magnet short-circuit magnetic flux B does not enter the narrow portion 250 at all, but also includes a case in which the magnetic flux slightly enters via a gap or a case in which the short-circuit magnetic flux slightly enters via a core. Also in such a case, it is possible to improve reluctance torque by enlarging the flux barrier.

In this configuration, the short-circuit magnetic flux passing through a core from the first-layer magnet 221 or the second-layer magnet 222 does not enter the narrow portion 250 formed between the first-layer center flux barrier 231 and the second-layer center flux barrier 232. Therefore, the narrow portion 250 only has to allow an armature magnetic flux generated by the stator 10 to pass, and the distance between the first-layer center flux barrier 231 and the second-layer center flux barrier 232 can be shortened. Thus, the second-layer center flux barrier 232 can be made to protrude toward the radially outer side from the flux barrier layer for second layer, so that the inductance on the d axis can be reduced, whereby reluctance torque can be improved.

In addition, since the second-layer center flux barrier 232 is formed so as to protrude toward the radially outer side from the flux barrier layer for second layer, the weight of the rotor core 21 on the radially outer side from the flux barrier layer for second layer can be reduced. Thus, a centrifugal force applied to a pair of second-layer rib portions 252 formed between the second-layer magnet slots 242 and the second-layer center flux barrier 232 when the rotor 20 is rotated, can be relaxed. Therefore, the width in the circumferential direction of the second-layer rib portion 252 can be reduced, and the short-circuit magnetic flux of the second-layer magnet 222 which is short-circuited by passing through the second-layer rib portion 252 can be reduced. Further, since a core for passing the magnetic flux in the d-axis direction can be reduced, the magnetic resistance on the d axis increases, so that the d-axis inductance can be reduced, whereby reluctance torque can be improved.

### Second Embodiment

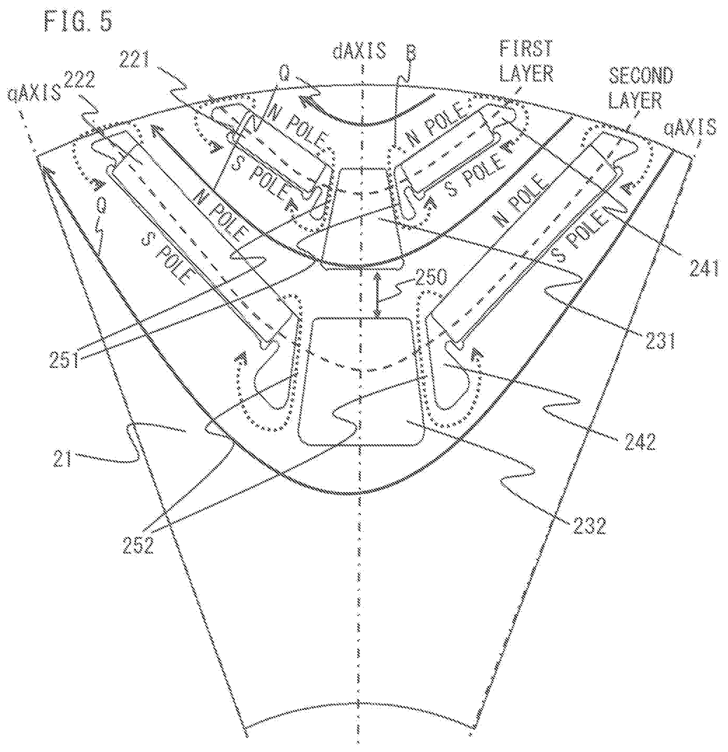

FIG. 5 is a sectional view taken along a direction perpendicular to a rotation axis of a rotor of a rotating electric machine according to the second embodiment of the present disclosure. In FIG. 5, in the flux barrier layer for first layer, the first-layer center flux barrier 231 protrudes toward the radially inner side with respect to the first-layer magnet slots 241. The radially outer side of the second-layer center flux barrier 232 is approximately aligned with the radially outer side of the flux barrier layer for second layer. The other configurations are the same as in the first embodiment. Also in this configuration, the magnet magnetic flux short-circuited through the first-layer rib portion 251 does not enter the narrow portion 250 between the first-layer center flux barrier 231 and the second-layer center flux barrier 232. Therefore, the distance between the first-layer center flux barrier 231 and the second-layer center flux barrier 232 can be reduced and the first-layer center flux barrier 231 can be made so as to become large, so that the magnetic resistance on the d axis increases, whereby the d-axis inductance can be reduced.

In addition, since the weight of the rotor core 21 on the radially outer side from the flux barrier layer for second layer can be reduced, a centrifugal force applied to the pair of second-layer rib portions 252 formed between the second-layer center flux barrier 232 and the second-layer magnet slots 242 when the rotor 20 is rotated, can be relaxed. Therefore, the width in the circumferential direction of the second-layer rib portions 252 can be reduced, and the short-circuit magnetic flux of the second-layer magnet 222 short-circuited through the second-layer rib portions 252 can be reduced. Further, since a core for passing the magnetic flux in the d-axis direction can be reduced, the magnetic resistance on the d axis increases, so that the d-axis inductance can be reduced, whereby reluctance torque can be improved. Since the first-layer center flux barrier 231 is expanded toward the radially inner side, the weight of the rotor core 21 on the radially outer side can be reduced as compared to a case of expanding the second-layer center flux barrier 232. Thus, a centrifugal force applied to the second-layer rib portions 252 can be further reduced. Therefore, the width in the circumferential direction of the second-layer rib portions 252 can be reduced, so that the difference between the d-axis inductance and the q-axis inductance can be further increased, whereby reluctance torque can be further improved.

### Third Embodiment

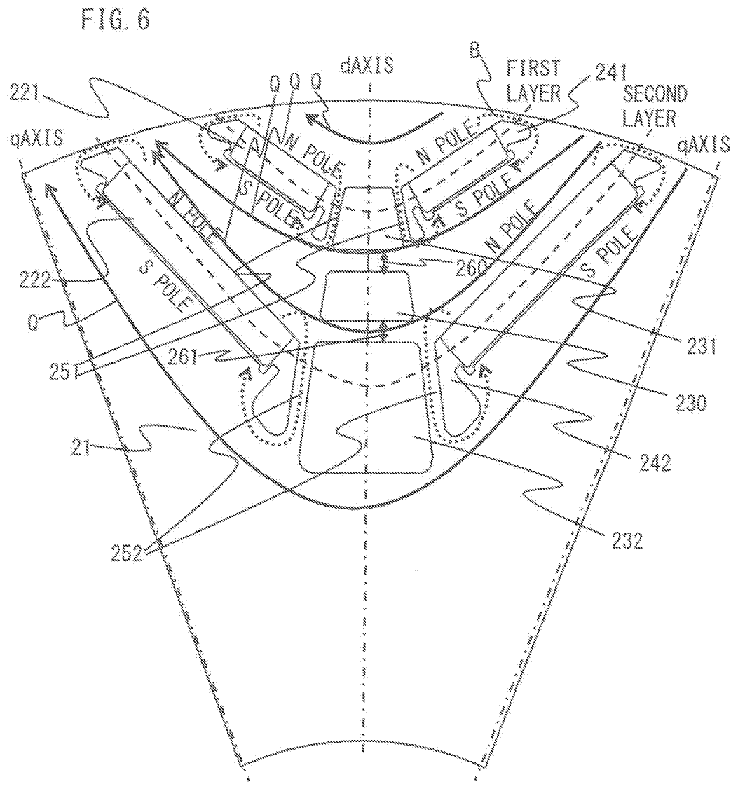

FIG. 6 is a sectional view taken along a direction perpendicular to a rotation axis of a rotor of a rotating electric machine according to the third embodiment of the present disclosure. In FIG. 6, the radially inner side of the first-layer center flux barrier 231 is approximately aligned with the radially inner side of the flux barrier layer for first layer. The radially outer side of the second-layer center flux barrier 232 is approximately aligned with the radially outer side of the flux barrier layer for second layer. In a radial-direction interval between the first-layer center flux barrier 231 and the second-layer center flux barrier 232, an intermediate center flux barrier 230 is provided so as to pass the d axis. A narrow portion 260 is formed between the first-layer center flux barrier 231 and the intermediate center flux barrier 230, and a narrow portion 261 is formed between the second-layer center flux barrier 232 and the intermediate center flux barrier 230. The sum of the distances of the narrow portion 260 and the narrow portion 261 is smaller than the distance between the flux barrier layer for first layer and the flux barrier layer for second layer at any part other than the narrow portions. The other configurations are the same as in the first embodiment.

Also in this configuration, the magnet short-circuit magnetic flux B short-circuited through the first-layer rib portions 251 or the second-layer rib portions 252 does not enter the narrow portion 260 between the first-layer center flux barrier 231 and the intermediate center flux barrier 230, and the narrow portion 261 between the second-layer center flux barrier 232 and the intermediate center flux barrier 230. Therefore, the distance between the first-layer center flux barrier 231 and the intermediate center flux barrier 230 can be shortened, and the distance between the second-layer center flux barrier 232 and the intermediate center flux barrier 230 can be shortened. Whereby the dimension in the radial direction of the intermediate center flux barrier 230 can be increased. Thus, the d-axis inductance can be reduced.

In addition, since the weight of the rotor core 21 on the radially outer side from the flux barrier layer for second layer can be reduced, a centrifugal force applied to the pair of second-layer rib portions 252 formed between the second-layer center flux barrier 232 and the second-layer magnet slots 242 when the rotor 20 is rotated, can be relaxed. Therefore, the width in the circumferential direction of the second-layer rib portions 252 can be reduced, and the short-circuit magnetic flux of the second-layer magnet 222 short-circuited through the second-layer rib portions 252 can be reduced. Further, since a core for passing the magnetic flux in the d-axis direction can be reduced, the magnetic resistance on the d axis increases, so that the d-axis inductance can be reduced, whereby reluctance torque can be improved. Since the flux barrier is separately added between the flux barrier layer for first layer and the flux barrier layer for second layer, the radial-direction position of the intermediate center flux barrier 230 can be freely selected. Whereby it is possible to optimally design the rotating electric machine, considering a combination of the effect of improving reluctance torque by adding the flux barrier and the effect of improving reluctance torque by reduction in the circumferential-direction width of the rib portion owing to weight reduction.

### Fourth Embodiment

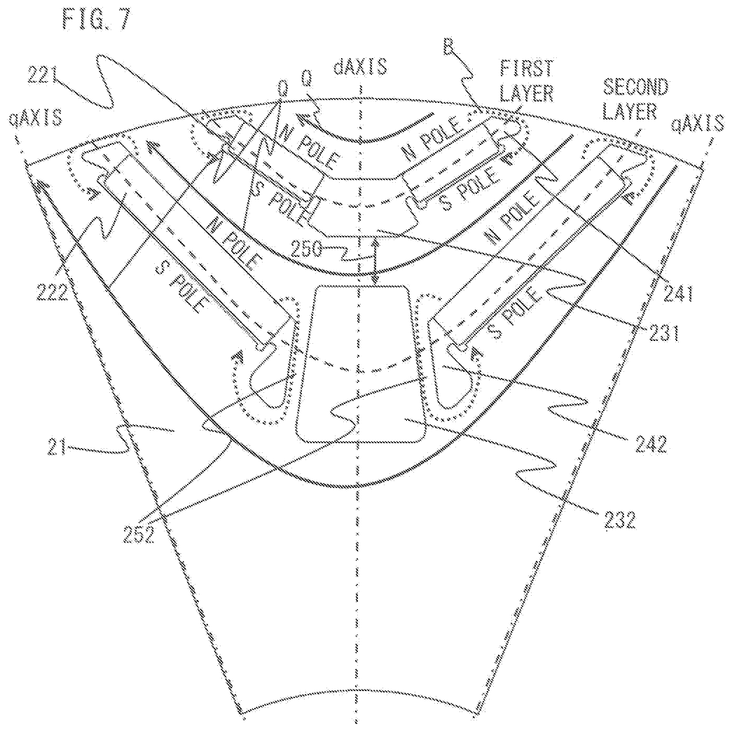

FIG. 7 is a sectional view taken along a direction perpendicular to a rotation axis of a rotor of a rotating electric machine according to the fourth embodiment of the present disclosure. In FIG. 7, the first-layer center flux barrier 231 and the first-layer magnet slots 241 are formed integrally with each other. The second-layer center flux barrier 232 protrudes toward the radially outer side and the radially inner side from the flux barrier layer for second layer. The narrow portion 250 is formed between the first-layer center flux barrier 231 and the second-layer center flux barrier 232, and the distance between the first-layer center flux barrier 231 and the second-layer center flux barrier 232 is the smallest among distances between the flux barrier layer for first layer and the flux barrier layer for second layer. The other configurations are the same as in the first embodiment.

Also in this configuration, the magnet short-circuit magnetic flux short-circuited through the second-layer rib portions 252 does not enter the narrow portion 250 between the first-layer center flux barrier 231 and the second-layer center flux barrier 232. Therefore, the distance between the first-layer center flux barrier 231 and the second-layer center flux barrier 232 can be shortened, and the radial-direction size of the second-layer center flux barrier 232 can be increased, so that the magnetic resistance on the d axis increases, whereby the d-axis inductance can be reduced.

In addition, since the weight of the rotor core 21 on the radially outer side from the flux barrier layer for second layer can be reduced, a centrifugal force applied to the pair of second-layer rib portions 252 formed between the second-layer center flux barrier 232 and the second-layer magnet slots 242 when the rotor 20 is rotated, can be relaxed. Therefore, the width in the circumferential direction of the second-layer rib portions 252 can be reduced, and the short-circuit magnetic flux of the second-layer magnet 222 short-circuited through the second-layer rib portion 252 can be reduced. Further, since a core for passing the magnetic flux in the d-axis direction can be reduced, the d-axis inductance can be reduced, whereby reluctance torque can be improved. Since the first-layer center flux barrier 231 and the first-layer magnet slots 241 are formed integrally with each other, there are no rib portions interposed therebetween. Whereby the d-axis inductance can be further reduced.

### Fifth Embodiment

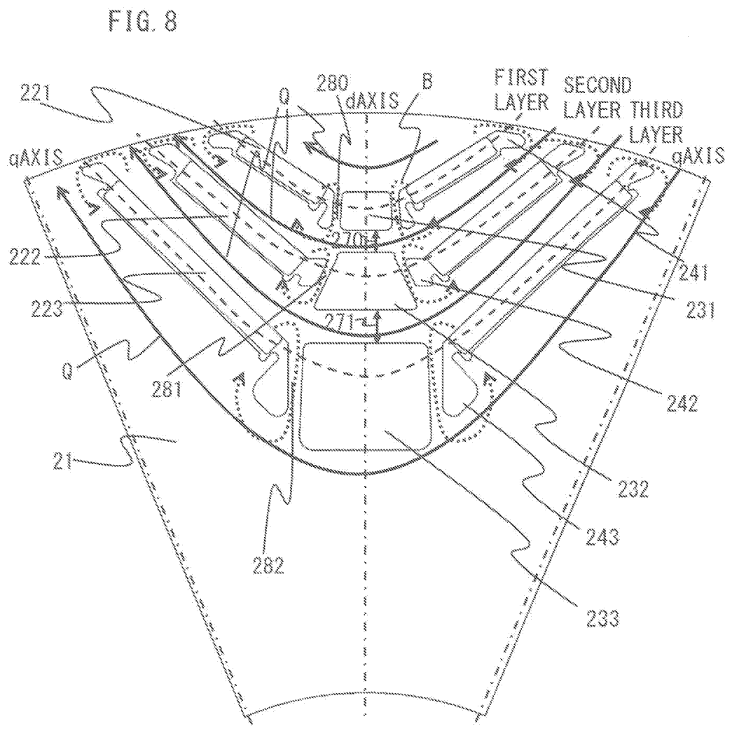

FIG. 8 is a sectional view taken along a direction perpendicular to a rotation axis of a rotor of a rotating electric machine according to the fifth embodiment of the present disclosure. In FIG. 8, the first-layer center flux barrier 231 and the pair of first-layer magnet slots 241 as a flux barrier are arranged so as to block the magnetic flux in the d-axis direction and allow the q-axis magnetic flux Q to pass, whereby the flux barrier layer for first layer is formed. In addition, the second-layer center flux barrier 232 and the pair of second-layer magnet slots 242 as a flux barrier similarly form the flux barrier layer for second layer. Further, a third-layer center flux barrier 233 and a pair of third-layer magnet slots 243 as a flux barrier similarly form a flux barrier layer for third layer. By the flux barrier layer for first layer, the flux barrier layer for second layer, and the flux barrier layer for third layer, a difference arises between the d-axis inductance and the q-axis inductance, whereby reluctance torque can be generated.

In the flux barrier layer for second layer, the second-layer center flux barrier 232 is formed so as to protrude toward the radially inner side and the radially outer side of the entire layer with respect to the second-layer magnet slots 242. The distance in the radial direction between the first-layer center flux barrier 231 and the second-layer center flux barrier 232 is the smallest among distances between the flux barrier layer for first layer and the flux barrier layer for second layer, and the smallest-distance part forms a narrow portion 270. In addition, the distance in the radial direction between the second-layer center flux barrier 232 and the third-layer center flux barrier 233 is the smallest among distances between the flux barrier layer for second layer and the flux barrier layer for third layer, and the smallest-distance part forms a narrow portion 271. Between the first-layer magnet slots 241 and the first-layer center flux barrier 231, a pair of rib portions 280 serving as short-circuit magnetic paths for the first-layer magnets 221 are formed. Ends on the second-layer center flux barrier 232 side of the rib portions 280 are located on the external side in the circumferential direction of the narrow portion 270 so that the magnet short-circuit magnetic flux B does not enter the narrow portion 270 through each rib portion 280.

In this configuration, the magnet short-circuit magnetic flux passing through the core from the first-layer magnet 221, the second-layer magnet 222, and the third-layer magnet 223 does not enter the narrow portion 270 formed between the first-layer center flux barrier 231 and the second-layer center flux barrier 232 and the narrow portion 271 formed between the second-layer center flux barrier 232 and the third-layer center flux barrier 233. Therefore, the narrow portions 270, 271 only have to allow an armature magnetic flux generated by the stator 10 to pass, the distance between the first-layer center flux barrier 231 and the second-layer center flux barrier 232 can be shortened, and further, the distance between the second-layer center flux barrier 232 and the third-layer center flux barrier 233 can be shortened. Thus, the second-layer center flux barrier 232 can be made so as to protrude toward the radially inner side and the radially outer side from the flux barrier layer for second layer, so that the magnetic resistance on the d axis increases. Whereby the inductance on the d axis can be reduced and reluctance torque can be improved.

In addition, since the second-layer center flux barrier 232 is formed so as to protrude toward the radially inner side and the radially outer side from the flux barrier layer for second layer, the weight of the rotor core 21 on the radially outer side from the flux barrier layer for second layer can be reduced and the weight of the rotor core 21 on the radially outer side from the flux barrier layer for third layer can be reduced. Thus, a centrifugal force applied to a pair of second-layer rib portions 281 formed between the second-layer magnet slots 242 and the second-layer center flux barrier 232 when the rotor 20 is rotated, can be relaxed. In addition, a centrifugal force applied to a pair of third-layer rib portions 282 formed between the third-layer magnet slots 243 and the third-layer center flux barrier 233 when the rotor 20 is rotated, can be relaxed. Therefore, the widths in the circumferential direction of the second-layer rib portions 281 and the third-layer rib portions 282 can be reduced, and the short-circuit magnetic flux of the second-layer magnets 222 short-circuited through the second-layer rib portions 281 and the short-circuit magnetic flux of the third-layer magnets 223 short-circuited through the third-layer rib portions 282 can be reduced. Further, since a core for passing the magnetic flux in the d-axis direction can be reduced, the magnetic resistance on the d axis increases, so that the d-axis inductance can be reduced, whereby reluctance torque can be improved.

In the above description, the case of providing two or three flux barrier layers has been described. However, four or more flux barrier layers may be provided.

The rotor has a pair of magnet slots provided so as to be opposed to each other such that a distance therebetween is narrowed toward a radially inner side while being centered at the d axis which is a magnetic pole center of the rotor core 21, a pair of magnets inserted in the pair of magnet slots, and center flux barriers provided on the d axis between the pair of magnet slots. The magnet slots, the magnets, and the center flux barriers are respectively configured so as to make N layers when N is an integer not less than 2.

And N flux barrier layers are formed by the magnet slots in the N layers and the center flux barriers in the N layers. And a distance in a radial direction between the (N−1)th-layer center flux barrier and the Nth-layer center flux barrier is the smallest among distances between the flux barrier layer for (N−1)th layer and the flux barrier layer for Nth layer.

Ends on the Nth-layer center flux barrier side of rib portions formed between the (N−1)th-layer center flux barrier and the (N−1)th-layer magnet slots are located on the external side in a circumferential direction with respect to a narrow portion formed between the (N−1)th-layer center flux barrier and the Nth-layer center flux barrier.

At least one side of a radially inner side and a radially outer side of at least one of the center flux barriers in the N layers protrudes with respect to the magnet slots belonging to the same layer as the center flux barrier.

An intermediate center flux barrier is provided on the d axis in at least one of radial-direction intervals between the (N−1)th-layer center flux barrier and the Nth-layer center flux barrier.

### Sixth Embodiment

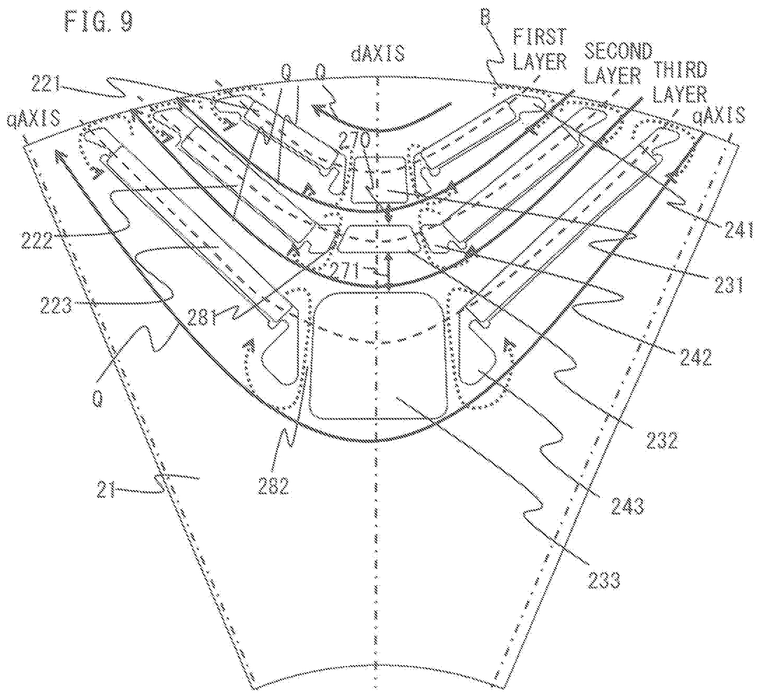

FIG. 9 is a sectional view taken along a direction perpendicular to a rotation axis of a rotor of a rotating electric machine according to the sixth embodiment of the present disclosure. In FIG. 9, the radially inner side of the first-layer center flux barrier 231 protrudes from the radially inner side of the flux barrier layer for first layer. The radially inner side and the radially outer side of the second-layer center flux barrier 232 are approximately aligned with the flux barrier layer for second layer. The radially outer side of the third-layer center flux barrier 233 protrudes from the radially outer side of the flux barrier layer for third layer, and the radially inner side of the third-layer center flux barrier 233 also protrudes from the radially inner side of the flux barrier layer for third layer. The other configurations are the same as in the fifth embodiment.

In this configuration, the short-circuit magnetic flux passing through the core from the first-layer magnet 221, the second-layer magnet 222, and the third-layer magnet 223 does not enter the narrow portion 270 formed between the first-layer center flux barrier 231 and the second-layer center flux barrier 232 and the narrow portion 271 formed between the second-layer center flux barrier 232 and the third-layer center flux barrier 233. Therefore, the narrow portions 270, 271 only have to allow an armature magnetic flux generated by the stator 10 to pass, the distance between the first-layer center flux barrier 231 and the second-layer center flux barrier 232 can be shortened, and the distance between the second-layer center flux barrier 232 and the third-layer center flux barrier 233 can be shortened.

Thus, the first-layer center flux barrier 231 can be made so as to protrude toward the radially inner side from the flux barrier layer for first layer, so that the inductance on the d axis can be reduced, whereby reluctance torque can be improved. In addition, since the third-layer center flux barrier 233 is formed so as to protrude toward the radially outer side from the flux barrier layer for third layer, the weight of the rotor core 21 on the radially outer side from the flux barrier layer for second layer and the weight of the rotor core 21 on the radially outer side from the flux barrier layer for third layer, can be reduced. Thus, a centrifugal force applied to the pair of second-layer rib portions 281 formed between the second-layer magnet slots 242 and the second-layer center flux barrier 232 when the rotor 20 is rotated, can be relaxed. In addition, a centrifugal force applied to the pair of third-layer rib portions 282 formed between the third-layer magnet slots 243 and the third-layer center flux barrier 233 when the rotor 20 is rotated, can be relaxed. Therefore, the widths in the circumferential direction of the second-layer rib portions 281 and the third-layer rib portions 282 can be reduced, the short-circuit magnetic flux of the second-layer magnet 222 short-circuited through the second-layer rib portions 281 can be reduced, and the short-circuit magnetic flux of the third-layer magnet 223 short-circuited through the third-layer rib portions 282 can be reduced. Further, since a core for passing the magnetic flux in the d-axis direction can be reduced, the magnetic resistance on the d axis increases, so that the d-axis inductance can be reduced. Whereby reluctance torque can be improved.

### Seventh Embodiment

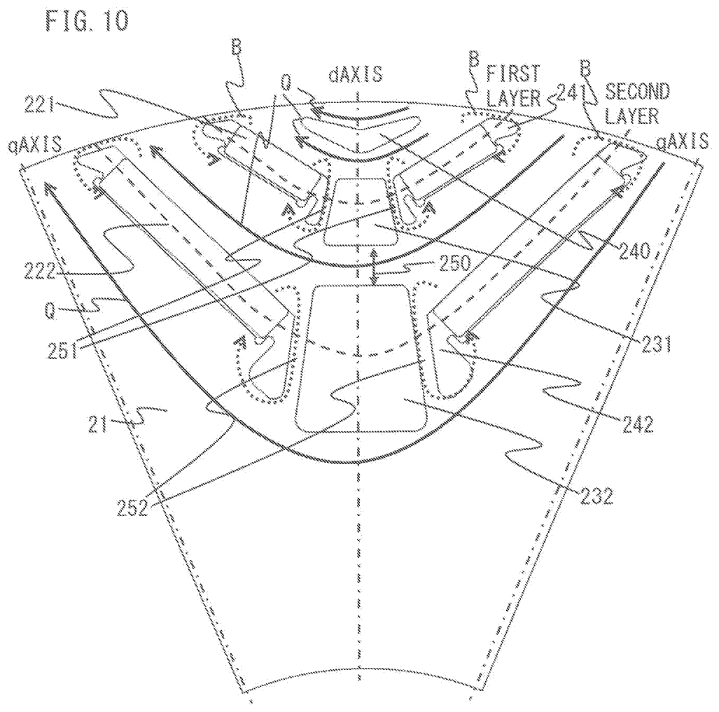

FIG. 10 is a sectional view taken along a direction perpendicular to a rotation axis of a rotor of a rotating electric machine according to the seventh embodiment of the present disclosure. In FIG. 10, a flux barrier 240 having no magnets is disposed on the radially outer side of the flux barrier layer for first layer. Thus, the difference between the d-axis inductance and the q-axis inductance can be further increased, whereby reluctance torque can be further improved. The radially inner side of the first-layer center flux barrier 231 protrudes toward the radially inner side from the flux barrier layer for first layer. In addition, the radially outer side and the radially inner side of the second-layer center flux barrier 232 protrude toward the radially outer side and the radially inner side from the flux barrier layer for second layer. The other configurations are the same as in the first embodiment.

Also in this configuration, the magnet short-circuit magnetic flux short-circuited through the first-layer rib portion 251 does not enter the narrow portion 250 between the first-layer center flux barrier 231 and the second-layer center flux barrier 232. Therefore, the distance between the first-layer center flux barrier 231 and the second-layer center flux barrier 232 can be shortened. In addition, since the sizes in the radial direction of the first-layer center flux barrier 231 and the second-layer center flux barrier 232 can be increased, the d-axis inductance can be reduced. In addition, since the weight of the rotor core 21 on the radially outer side from the flux barrier layer for second layer can be reduced, a centrifugal force applied to the pair of second-layer rib portions 252 formed between the second-layer center flux barrier 232 and the second-layer magnet slots 242 when the rotor 20 is rotated, can be relaxed.

Therefore, the width in the circumferential direction of the second-layer rib portions 252 can be reduced, and the magnet short-circuit magnetic flux of the second-layer magnet 222 short-circuited through the second-layer rib portions 252 can be reduced. Further, since a core for passing the magnetic flux in the d-axis direction can be reduced, the magnetic resistance on the d axis increases, so that the d-axis inductance can be reduced. Whereby reluctance torque can be improved. Since the first-layer center flux barrier 231 is expanded in the radial direction, the weight of the rotor core 21 on the radially outer side can be reduced as compared to a case of expanding the second-layer center flux barrier 232 in the radial direction. Thus, the centrifugal force applied to the second-layer rib portions 252 can be further reduced, so that the circumferential-direction width of the second-layer rib portions 252 can be reduced. And the difference between the d-axis inductance and the q-axis inductance can be further increased, whereby reluctance torque can be further improved.

Hereinafter, modes of the present disclosure are summarized as additional notes.

(Additional note 1)

A rotating electric machine comprising:
a stator; and
a rotor provided on an inner circumferential side of the stator, wherein
the rotor has a rotor core fixed to a shaft, a pair of magnet slots provided so as to be opposed to each other such that a distance therebetween is narrowed toward a radially inner side while being centered at a d axis which is a magnetic pole center of the rotor core, a pair of magnets inserted in the pair of magnet slots, and center flux barriers provided on the d axis between the pair of magnet slots,
the magnet slots, the magnets, and the center flux barriers are respectively configured so as to make N layers when N is an integer not less than 2, and
N flux barrier layers are formed by the magnet slots in the N layers and the center flux barriers in the N layers, and a distance in a radial direction between the (N−1)th-layer center flux barrier and the Nth-layer center flux barrier is the smallest among distances between the flux barrier layer for (N−1)th layer and the flux barrier layer for Nth layer.

(Additional note 2)

The rotating electric machine according to additional note 1, wherein
ends on the Nth-layer center flux barrier side of rib portions formed between the (N−1)th-layer center flux barrier and the (N−1)th-layer magnet slots are located on the external side in a circumferential direction with respect to a narrow portion formed between the (N−1)th-layer center flux barrier and the Nth-layer center flux barrier.

(Additional note 3)

The rotating electric machine according to additional note 1 or 2, wherein
at least one side of a radially inner side and a radially outer side of at least one of the center flux barriers in the N layers protrudes with respect to the magnet slots belonging to the same layer as the center flux barrier.

(Additional note 4)

The rotating electric machine according to additional note 1 or 2, wherein
an intermediate center flux barrier is provided on the d axis in at least one of radial-direction intervals between the (N−1)th-layer center flux barrier and the Nth-layer center flux barrier.

(Additional note 5)

The rotating electric machine according to any one of additional notes 1 to 4, wherein
the first-layer center flux barrier and the first-layer magnet slots are integrally formed with each other.

(Additional note 6)

The rotating electric machine according to any one of additional notes 1 to 5, wherein
a flux barrier having no magnets is provided on a radially outer side of the flux barrier layer for first layer.

Although the disclosure is described above in terms of various exemplary embodiments and implementations, it should be understood that the various features, aspects, and functionality described in one or more of the individual embodiments are not limited in their applicability to the particular embodiment with which they are described, but they can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A rotating electric machine comprising:
a stator; and
a rotor provided on an inner circumferential side of the stator, wherein
the rotor has a rotor core fixed to a shaft, a pair of magnet slots provided so as to be opposed to each other such that a distance therebetween is narrowed toward a radially inner side while being centered at a d axis which is a magnetic pole center of the rotor core, a pair of magnets inserted in the pair of magnet slots, and center flux barriers provided on the d axis between the pair of magnet slots,
the magnet slots, the magnets, and the center flux barriers are respectively configured so as to make N layers when N is an integer not less than 2, and
N flux barrier layers are formed by the magnet slots in the N layers and the center flux barriers in the N layers, and a distance in a radial direction between the (N−1)th-layer center flux barrier and the Nth-layer center flux barrier is the smallest among distances between the flux barrier layer for (N−1)th layer and the flux barrier layer for Nth layer.

2. The rotating electric machine according to claim 1, wherein
ends on the Nth-layer center flux barrier side of rib portions formed between the (N−1)th-layer center flux barrier and the (N−1)th-layer magnet slots are located on the external side in a circumferential direction with respect to a narrow portion formed between the (N−1)th-layer center flux barrier and the Nth-layer center flux barrier.

3. The rotating electric machine according to claim 1, wherein
at least one side of a radially inner side and a radially outer side of at least one of the center flux barriers in the N layers protrudes with respect to the magnet slots belonging to the same layer as the center flux barrier.

4. The rotating electric machine according to claim 1, wherein
an intermediate center flux barrier is provided on the d axis in at least one of radial-direction intervals between the (N−1)th-layer center flux barrier and the Nth-layer center flux barrier.

5. The rotating electric machine according to claim 1, wherein
the first-layer center flux barrier and the first-layer magnet slots are integrally formed with each other.

6. The rotating electric machine according to claim 1, wherein
a flux barrier having no magnets is provided on a radially outer side of the flux barrier layer for first layer.

7. The rotating electric machine according to claim 2, wherein
at least one side of a radially inner side and a radially outer side of at least one of the center flux barriers in the N layers protrudes with respect to the magnet slots belonging to the same layer as the center flux barrier.

8. The rotating electric machine according to claim 2, wherein
an intermediate center flux barrier is provided on the d axis in at least one of radial-direction intervals between the (N−1)th-layer center flux barrier and the Nth-layer center flux barrier.

9. The rotating electric machine according to claim 2, wherein
the first-layer center flux barrier and the first-layer magnet slots are integrally formed with each other.

10. The rotating electric machine according to claim 3, wherein
the first-layer center flux barrier and the first-layer magnet slots are integrally formed with each other.

11. The rotating electric machine according to claim 4, wherein
the first-layer center flux barrier and the first-layer magnet slots are integrally formed with each other.

12. The rotating electric machine according to claim 7, wherein
the first-layer center flux barrier and the first-layer magnet slots are integrally formed with each other.

13. The rotating electric machine according to claim 8, wherein
the first-layer center flux barrier and the first-layer magnet slots are integrally formed with each other.

14. The rotating electric machine according to claim 2, wherein
a flux barrier having no magnets is provided on a radially outer side of the flux barrier layer for first layer.

15. The rotating electric machine according to claim 3, wherein
a flux barrier having no magnets is provided on a radially outer side of the flux barrier layer for first layer.

16. The rotating electric machine according to claim 4, wherein
a flux barrier having no magnets is provided on a radially outer side of the flux barrier layer for first layer.

17. The rotating electric machine according to claim 5, wherein
a flux barrier having no magnets is provided on a radially outer side of the flux barrier layer for first layer.

18. The rotating electric machine according to claim 7, wherein
a flux barrier having no magnets is provided on a radially outer side of the flux barrier layer for first layer.

19. The rotating electric machine according to claim 8, wherein
a flux barrier having no magnets is provided on a radially outer side of the flux barrier layer for first layer.

20. The rotating electric machine according to claim 9, wherein
a flux barrier having no magnets is provided on a radially outer side of the flux barrier layer for first layer.
